(19) United States
(12) Patent Application Publication
(10) Pub. No.: US 2002/0142106 A1
(43) Pub. Date: Oct. 3, 2002

(54) Method of applying material to a substrate

(76) Inventors: Alain Bethune, Savigny (FR); Sophie Helene Vayrette, Courbevoie (FR)

Correspondence Address: Thomas L. Irving, FINNEGAN, HENDERSON, FARABOW,, GARRETT & DUNNER , L.L.P., 1300 I Street, N.W., Washington, DC, 20005-3315, US

(21) Appl. No.: 10/079,521

(22) Filed: Feb. 22, 2002

(30) Foreign Application Priority Data
Feb. 22, 2001 (FR) 01 02412

(51) Int. Cl. B05D 3/06

(52) U.S. Cl. 427/553

(57) ABSTRACT

A method of applying a material to a substrate includes depositing on the substrate an ink-based solution comprising thermally expandable particles and exposing the substrate to microwave radiation such that the particles become at least partially expanded.

The present invention relates to a method of applying material to a substrate. The method may relate to printing by ink deposition and, more particularly, printing in order to obtain a relief effect on a substrate.

Conventional techniques for printing by ink deposition include, for example, offset printing, dry offset printing, photogravure, flexography, letterpress printing, screen printing, and pad printing. Of these techniques, screen printing makes it possible to obtain a significant relief, i.e., an ink thickness of about 15 to 100 μm, on a substrate, while the other techniques usually allow an ink thickness of only about 2 to 10 μm to be deposited on a substrate. However, screen printing is a relatively expensive printing technique, since it is relatively slow.

Other techniques for obtaining a relief effect include, for example, the use of expanding agents in inks. These agents, such as those described in U.S. Pat. No. 3,615,972, are made of particles which expand under the effect of heat. It is known to use these particles in screen-printing and photogravure inks in order to obtain reliefs on substrates such as textiles and relief wallpapers. Drying of the substrates is carried out in a conventional oven. However, relatively lengthy drying is required to allow the particles to expand properly. The substrate coated with these inks must be exposed to a temperature from 80 to 130° C. for one to five minutes.

Expanding agents have also been used to obtain relief effects in other printing techniques, such as, for example, that described in U.S. Pat. No. 6,004,419 for writing in Braille. This patent describes a method of printing by heat transfer in which a film comprising a substrate coated with an expanding agent and a layer of ink is brought into contact with a sheet receiving the print. The film is heated in the regions to be transferred, then pressure is applied to this region so as to transfer the ink coated with the expanding agent onto the sheet. Subsequently, heat energy is applied to the printed sheet in the form of light having a wavelength from 1 to 4 μm in order to swell the expanding agent. Like other conventional techniques, this technique of printing by heat transfer is also relatively expensive due to the cost of the film itself, as well as the need for two steps, namely, the step of transferring ink by pressure and the step of drying the sheet.

EP-A-526 396 also describes the use of expanding agents in inks that are deposited on a two-dimensional substrate. The two-dimensional substrate undergoes conventional drying at a temperature below the expansion temperature of the expanding agents so as to dry the ink. The substrate is then used to form objects which are then exposed to a laser beam so as to swell the expanding agents. A method of this sort is still relatively slow. Two distinct and successive steps are used to dry the ink and to make the expanding agents swell, each of the steps being relatively slow. The first step, in which the ink is dried in a conventional oven, requires a relatively long drying time. The second step, expanding the particles by means of a laser, is not quick either since the laser is applied in a very point-like manner. Furthermore, it is not possible to accelerate the method by using just one of the two steps to carry out both the drying and the expansion of the particles for several reasons. First, the expansion of the particles in a conventional oven would require a relatively long drying time in order to allow the proper expansion of the particles. Second, the use of a laser would not allow fast drying of the ink without the whole substrate being damaged.

Lastly, EP-A-0 348 372 describes a method of producing expanded thermoplastic microspheres while limiting the formation of agglomerate. The method includes drying the particles which have not yet expanded, and then expanding them by heating. This document describes the expansion of dry particles by various means, including infrared radiation, hot air, steam, microwaves, or a hot-extrusion system. Infrared radiation is presented as the preferred expansion means, but infrared radiation is not believed to obtain very fast expansion of the particles. While EP-A-0 348 372 discloses various heating means for expanding dry particles, the heating is used to produce the particles themselves rather than being used as part of a process including application of material to a substrate.

One of the aspects of the present invention relates to applying material to a substrate.

Another aspect relates to a method of printing by ink deposition that enables a relief to be obtained.

Yet another aspect of the invention relates to a relatively fast method that makes it possible to reduce the costs of printing, while obtaining a significant relief.

Still another aspect relates to solving one or more problems associated with conventional methods.

Other aspects will become apparent in the following description. It should be understood that the invention, in its broadest sense, could be practiced without having one or more of the aspects described herein.

According to an aspect of the invention, a method of applying a material to a substrate may comprise depositing on the substrate an ink-based solution comprising thermally expandable particles. The method may further comprise exposing the substrate to microwave radiation such that the particles become at least partially expanded. As used herein, the term “microwave radiation”refers to ultra-high frequency waves whose frequency band ranges from 100 MHz to 300 GHz.

Optionally, the material applied to the substrate may form one or more decorations on the substrate.

The microwave radiation may make it possible for the thermally expandable particles to expand very quickly. The microwaves may change the orientation of water molecules present in the ink, causing the ink to be quickly heated. The heat of the ink, in turn, may quickly heat the thermally expandable particles, causing them to expand.

In one exemplary embodiment according to the present invention, it may be possible to produce a given relief on a substrate with a flexography printing process having machines operating up to two and a half times faster than with a conventional screen printing process.

In addition, microwave-generating devices, such as microwave ovens, may enable substantially the whole substrate to be irradiated at the same time, rather than sweeping the substrate. This simultaneous irradiation of substantially the entire substrate may make it possible to obtain maximum expansion of virtually all of the particles in a very short time. Since the time of exposure to the microwave energy is very short, it may be possible to use particles which have a very small unexpanded volume and to quickly obtain a significant and homogeneous relief on a substrate. Such small-volume unexpanded particles may be used in ink-based solutions that are deposited by a flexographic plate, unlike pre-expanded particles having a larger volume.

According to an exemplary embodiment of the method, the ink-based solution deposited on the substrate may be dried when the substrate is exposed to the microwave radiation, i.e., simultaneously with the expansion of the thermally expandable particles. Accordingly, such an embodiment might not have an additional step for the expansion of the particles, when compared to a method utilizing conventional ink. Optionally, the particle expansion may not increase the total printing time since it may be carried out at the same time as the ink-drying step. The simultaneous drying and particle expansion may allow the method to be carried out very quickly.

The thermally expandable particles may be formed from hollow microspheres made of a thermoplastic material containing a volatilizable substance, such as a gas, for example. Under the effect of heat, the thermoplastic softens and the gas pressure inside increases, which leads to expansion of the microsphere, for example, by 30 to 50 times its initial volume. For example, the thermoplastic may be chosen from vinyl chlorides, vinylidene chlorides, acrylonitriles, methyl methacrylates, and styrenes. The microspheres may contain a gas chosen from freons or hydrocarbons, for example. More generally, any thermally expandable particle described in U.S. Pat. No. 3,615,972 may be used.

In one embodiment, microspheres having an unexpanded diameter less than or equal to 15 μm may be used. In a further embodiment, microspheres having an unexpanded diameter less than or equal to 9 μm may be used. In a still further embodiment, microspheres having an unexpanded diameter less than or equal to 6 μm may be used. As used herein, the term “diameter”relates to the maximum dimension of a microsphere and does not necessarily require the microsphere having an exact spherical shape or substantially spherical shape. For example, the term “diameter”may relate to the diameter of an imaginary sphere surrounding a microsphere having a non-spherical shape.

In one embodiment, the ink solution may comprise 5 to 30 by weight of expandable particles. In another embodiment, the ink solution may comprise 5 to 15% by weight of expandable particles. Such an amount may make it possible to obtain a significant relief without applying an amount of ink-based solution that is excessively large.

In one embodiment, the substrate may be exposed to microwaves having a frequency ranging from 100 MHz to 300 GHz. In another embodiment, the substrate may be exposed to microwaves having a frequency ranging from 2000 MHz to 2500 MHz.

In one embodiment, the substrate may be exposed to microwaves for a time ranging from 1 to 10 seconds. In another embodiment, the substrate may be exposed to microwaves for a time ranging from 1 to 4 seconds. Such an exposure time may make it possible to both dry the ink and to obtain optimum expansion of the particles. Thus, this step may be relatively short and may provide a very fast and therefore inexpensive method.

The ink-based solution may be an aqueous solution comprising 15 to 25% by weight of a colored pigment and 75 to 85% by weight of a liquid varnish, which carries the color throughout the print and which gives the gloss to the decoration obtained. The water molecules present, which are agitated by the microwaves, may make it possible for the deposited ink to dry and for the thermally expandable particles to expand. The inkbased solution may also comprise additives in an amount of 0 to 5%, which may make it possible, for example, to fix the color and the gloss and improve the abrasion resistance of the decoration (e.g., relief) obtained.

The ink-based solution may be deposited on the substrate by means of a technique chosen from offset printing, photogravure, flexography, letterpress printing, and pad printing. It may be possible to choose a suitable printing technique for the object to be decorated. The method of the invention may therefore be used to decorate various types of objects.

Another aspect of the invention relates to an article including a substrate and a material applied to the substrate using the method. The article may be in the form of a packaging article. The packaging article may be chosen from bottles, containers, pots (e.g., jars), and boxes, such as boxes made of cardboard or of a cardboard-like material (e.g., bendable sheet material). Alternatively, the article may be in the form of a label intended, for example, to be adhered to such a packaging article. In another embodiment, the article may be in the form of a packaging article including a label applied thereto. The material applied to the substrate of the article may be in the form of one or more decorations.

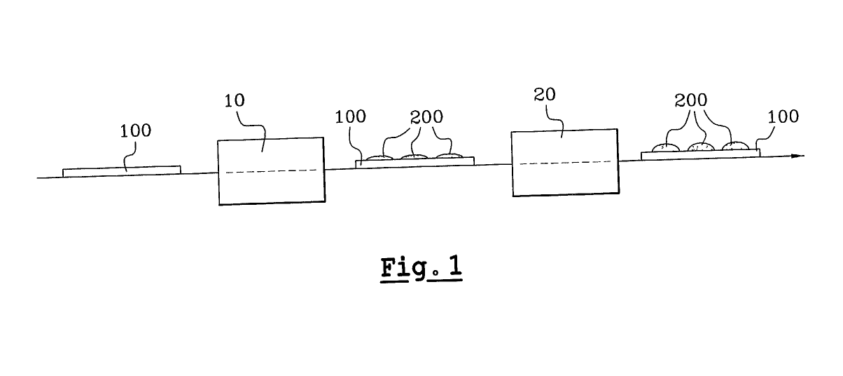

The accompanying drawing, FIG. 1, is included to provide a further understanding of certain aspects of the invention and is incorporated in and constitutes part of the specification. FIG. 1 schematically illustrates an exemplary embodiment of a method according to the invention.

As shown in FIG. 1, a substrate 100 is provided. The substrate 100 may be in the form of any type of article, such as, for example, a flat label which may be adhered to a bottle, box, or any other type of packaging article. When the substrate is a label, the substrate may comprise a synthetic film, such as, for example, polyethylene or polypropylene, having an adhesive face, and a sheet of removable paper may cover the adhesive face of the film in order to protect it. Optionally, a surface treatment (e.g., a corona treatment) may be applied to the synthetic film beforehand in order to enhance printability.

An ink solution 200 comprising a water-based printing ink may be used in the method shown schematically in FIG. 1. For example, an ink marketed under the reference HYDROFILM4000 by Akzo Nobel may used. Other types of printing ink may also be used.

A blowing agent (i.e., expanding agent) formed from thermally expandable particles (e.g., microspheres) in the form of a dry powder may be incorporated into the ink solution 200. The blowing agent may be, for example, a blowing agent referred to as EXPANCEL and having the reference Akzo Nobel No. 551/20 DU, but it should be understood that many other products having expandable particles may be used. For example, the blowing agent may have microspheres with a diameter of about 6 μm. The amount of blowing agent may represent, for example, about 15% by weight of the ink solution. The solution thus obtained may be agitated in order to obtain a homogeneous mixture.

FIG. 1 shows various steps of the exemplary method. The ink solution 200 comprising the blowing agent is deposited on the substrate 100 to be decorated by means of a flexographic plate 10, which has been coated with the ink solution. The plate 10 may have a pattern corresponding to the desired printing pattern. Before the blowing agent is expanded, the thickness of ink deposited on the substrate may be about 10 μm.

After the ink is deposited on the substrate, the substrate may be inserted into a microwave-generating device 20 (e.g., microwave oven) operating at a frequency of 2450 MHz and a power of 0.8 kW, without drying the ink beforehand. The substrate may be irradiated for 1 to 4 seconds. During this irradiation, the particles become expanded and the ink deposited on the substrate is dried.

On exiting the device 20, the ink thickness on the substrate may be about 100 μm. Thus, the method may provide a decorated substrate with a significant optical relief effect.

Other types of substrates may be decorated using the method according to the invention by using, for example, an appropriate printing technique.

Although certain examples are described in terms of applying one or more decorations to a substrate, it should be understood that the invention, in its broadest sense, is not limited to methods involving formation of decoration(s). For example, the method might be practiced to apply material to a substrate in the form of any type of coating.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

What is claimed is:

1. A method of applying material to a substrate, the method comprising:
depositing on the substrate an ink-based solution comprising thermally expandable particles; and
exposing the substrate to microwave radiation such that the particles become at least partially expanded.

2. The method of claim 1, wherein the exposing of the substrate to microwave radiation substantially dries the ink-based solution deposited on the substrate.

3. The method of claim 1, wherein the particles comprise hollow microspheres containing a volatilizable substance.

4. The method of claim 3, wherein the microspheres comprise a thermoplastic material.

5. The method of claim 3, wherein the volatilizable substance comprises a gas.

6. The method of claim 1, wherein the particles are EXPANCEL particles.

7. The method of claim 3, wherein the microspheres have an unexpanded diameter less than or equal to 15 μm.

8. The method of claim 7, wherein the microspheres have an unexpanded diameter less than or equal to 9 μm.

9. The method of claim 8, wherein the microspheres have an unexpanded diameter less than or equal to 6 μm.

10. The method of claim 1, wherein the ink-based solution comprises 5 to 30% by weight of expandable particles.

11. The method of claim 10, wherein the ink-based solution comprises 5 to 15% by weight of expandable particles.

12. The method of claim 1, wherein the microwave radiation has a wavelength ranging from 100 MHz to 300 GHz.

13. The method of claim 12, wherein the microwave radiation has a wavelength ranging from 2000 MHz to 2500 MHz.

14. The method of claim 1, wherein the exposing of the substrate to microwave radiation is carried out for a period of 1 to 10 seconds.

15. The method of claim 14, wherein the exposing of the substrate to microwave radiation is carried out for a period of 1 to 4 seconds.

16. The method of claim 1, wherein the ink-based solution is an aqueous solution.

17. The method of claim 16, wherein the ink-based solution comprises 15 to 25% by weight of a colored pigment and 75 to 85% by weight of a liquid varnish.

18. The method of claim 1, wherein the depositing on the substrate of the ink-based solution is carried out using a technique chosen from offset printing, photogravure, flexography, letterpress printing, and pad printing.

19. The method of claim 1, wherein the material applied to the substrate comprises at least one decoration.

20. An article comprising a substrate and a material applied to the substrate using the method of claim 1.

21. The article of claim 20, wherein the article is in the form of a packaging article.

22. The article of claim 21, wherein the packaging article is chosen from bottles, containers, pots, and boxes.

23. The article of claim 21, wherein the packaging article is in the form of a box made of one of cardboard and cardboard-like material.

24. The article of claim 20, wherein the article is in the form of a label.

25. The article of claim 20, wherein the article is in the form of a packaging article comprising a label applied thereto.

26. The method of claim 1, wherein the exposing of the substrate to microwave radiation comprises exposing the entire substrate to microwave radiation substantially simultaneously.
